(19) United States
(12) Patent Application Publication
(10) Pub. No.: US 2002/0115578 A1
(43) Pub. Date: Aug. 22, 2002

(54) Composition for cleaning and wetting contact lenses

(76) Inventor: Suzanne F. Groemminger, Rochester, NY (US)

Correspondence Address: John E. Thomas, Law Department, Bausch & Lomb Incorporated, One Bausch & Lomb Place, Rochester, NY, 14604, US

(21) Appl. No.: 09/737,004

(22) Filed: Dec. 14, 2000

(51) Int. Cl. B08B 11/00; C11D 1/00

(52) U.S. Cl. 510/112; 134/42

(57) ABSTRACT

An aqueous composition for cleaning and wetting a contact lens includes: a non-amine polyethyleneoxy-containing material having an HLB value of at least about 18; a first non-ionic surface active agent having cleaning activity for contact lens deposits that comprises a poloxamine; c) a second non-ionic surface active agent having cleaning activity for contact lens deposits and that comprises a non- poloxamine surface active agent; and a wetting agent.

### BACKGROUND OF THE INVENTION

The present invention relates to a composition for cleaning and wetting contact lenses.

A care regimen for contact lenses involves various functions, such as regularly cleaning the lens with a contact lens solution containing a surface-active agent as a primary cleaning agent. Rinsing of the contact lens is generally recommended following cleaning to remove loosened debris. Additionally, the regimen may include treatments to disinfect the lens, treatment to render the lens surface more wettable prior to insertion in the eye, or treatment to condition (e.g., lubricate or cushion) the lens surface so that the lens is more comfortable in the eye. As a further example, a contact lens wearer may need to rewet the lens during wear by administering directly in the eye a solution commonly referred to as rewetting drops.

Separate solutions may be provided for the individual segments of the care regimen. For convenience purposes, multipurpose contact lens solutions have gained popularity, i.e., solutions that can be used for several segments of the care regimen.

Multipurpose contact lens solutions that effectively clean a contact lens, and can also be used to treat the lens immediately prior to insertion of the lens in the eye or while the lens is worn in the eye, represent the more difficult multipurpose solutions to develop since the solution comes into direct contact with eye tissue. Conventional surface active agents having good cleaning activity for contact lens deposits, as well as various other components such as antimicrobial agents included as a preservative or disinfectant, tend to be irritating to the eye. Additionally, the surface-active agents must not inhibit the wetting or conditioning function of the solution.

U.S. Pat. No. 5,604,189 discloses multi-purpose compositions for cleaning and wetting contact lenses that include a polyethyleneoxide-containing material having a hydrophile-lipophile balance (HLB) of at least about 18, and a surface active agent having cleaning activity for contact lens deposits. The compositions provide effective cleaning activity, and are also effective at wetting surfaces of the lens. Additionally, the compositions achieve the desired cleaning but are relatively nonirritating to the eye. According to preferred embodiments, the compositions are sufficiently nonirritating that contact lenses treated with the composition can be inserted directly in the eye, i.e., without the need to rinse the composition from the lens, or the composition can be administered directly in the eye for use as a rewetting solution. Compositions of the type disclosed in Table 16 of this patent and marketed under the trademark “Simplicity” (Polymer Technology, Rochester, N.Y. USA) have shown commercial success as a multi-purpose solution for cleaning, conditioning, wetting and disinfecting rigid gas permeable (RGP) contact lenses.

### SUMMARY OF THE INVENTION

This invention provides an aqueous composition for cleaning and wetting contact lenses which comprises:

(a) a non-amine polyethyleneoxy-containing material having an HLB value of at least about 18;

(b) a first non-ionic surface active agent having cleaning activity for contact lens deposits that comprises a poloxamine;

(c) a second non-ionic surface active agent having cleaning activity for contact lens deposits and that comprises a non- poloxamine surface active agent; and

(d) a wetting agent.

These compositions provide improved cleaning, i.e., improved removal of contact lens deposits, as well as less eye irritation, as compared to the commercialized compositions of U.S. Pat. No. 5,604,189. According to various preferred embodiments, the compositions are effective at disinfecting a contact lens, yet employ a lower amount of antimicrobial agent thus further alleviating the potential for eye irritation.

### DETAILED DESCRIPTION OF PREFERRED EMBODIMENTS

The composition of this invention is an aqueous composition comprising the aforementioned components (a), (b), (c) and (d). Each of components (a), (b), (c) and (d) are mutually exclusive of one another, i.e., each of these components is a distinct material.

The first component is a non-amine polyethyleneoxy-containing material having a hydrophile-lipophile balance (HLB) of at least about 18. These materials are described in U.S. Pat. No. 5,604,189, the disclosure of which is incorporated herein by reference. Generally, the materials of this class are not particularly effective cleaners for contact lens deposits when employed as the primary cleaning agent. However, these high-HLB materials alleviate the potential of eye irritation of the compositions attributed to components such as the surface-active agent and other components.

In addition to homopolymers of polyethylene glycol or polyethyleneoxy, representative PEO-containing materials having an HLB value of at least 18 include certain polyethyleneoxy-polypropyleneoxy block copolymers, also known as poloxamers. Such materials are commercially available under the trade name Pluronic from BASF Corporation, Parsippany, N.J., USA, and include Pluronic Y108 and F127. Other suitable PEO-containing materials include ethoxylated glucose derivatives, such as methyl gluceth-20 including the product available as Glucam E-20 (Amerchol Corp., Edison, N.J., USA), and high HLB ethoxylated nonionic ethers of sorbitol or glycerol, such as products available under the trade name Ethosperse, including sorbeth-20 supplied as Ethosperse SL-20 and glycereth-26 supplied as Ethosperse G-26 (Lonza Inc., Fairlawn, N.J., USA).

Representative PEO-containing materials are listed in Table A with HLB value and molecular weight. For comparative purposes, two PEO-containing materials which do not have an HLB value of at least about 18 (the polysorbate Tween 20), and the poloxamer Pluronic P104) are included. The HLB values and molecular weight were provided by manufacturers, or calculated or estimated based on chemical structure.

TABLE A

| Material | HLB Value | Average MW |
|---|---|---|
| Pluronic P104 | 12-18 | 5,900 |
| Tween 20 | 16.7 | 1,200 |
| Ethosperse G-26 | 18 | 1,224 |
| Glucam E-20 | >18 | 1,074 |
| Pluronic F127 | 18-23 | 12,600 |
| Pluronic F108 | >24 | 14,600 |
| Polyethylene Glycol | >24 | 18,500 |

The PEO-containing materials may be employed in the compositions at about 0.001 to about 10 weight percent, preferably at about 0.001 to about 5 weight percent.

The composition further includes at least two non-ionic surface-active agents having cleaning activity for contact lens deposits.

The first surface active agent having cleaning activity for contact lens deposits comprises a poloxamine surface-active agent. These agents are polyethyleneoxy-polypropyleneoxy block copolymer adducts of ethylene diamine, e.g., poloxamine 1107 and poloxamine 1308. These materials are available under the trade name Tetronic from BASF Corp.

The second surface active agent having cleaning activity for contact lens deposits comprises a non-ionic surface-active agent other than a poloxamine. Such nonionic surface active agents include certain polyoxyethylene, polyoxypropylene block copolymer (poloxamer) surface active agents, including various surface active agents available under the trade name Pluronic from BASF Corp., e.g., Pluronic P104 or L64. (In contrast with the high-HLB PEO-containing materials, the poloxamers which may be employed as a primary cleaning agent in the compositions of this invention have an HLB value less than 18, generally about 12 to about 18.) Other representative nonionic surface active agents include: ethoxylated alkyl phenols, such as various surface active agents available under the trade names Triton (Union Carbide, Tarrytown, N.Y., USA) and Igepal (Rhone-Poulenc, Cranbury, N.J. USA); polysorbates such as polysorbate 20, including the polysorbate surface active agents available under the trade name Tween (ICI Americas, Inc., Wilmington, Del., USA); PEG-derivatives of lauramides and cocamides, such as PEG-6 lauramide and PEG-6 cocamide available under the trade name Amidox (Stepan Company, Northfield, Ill., USA); and alkyl glucosides and polyglucosides such as products available under the trade name Plantaren (Henkel Corp., Hoboken, N.J. USA).

Each of the first and second surface active agents having cleaning activity for contact lens deposits may be employed at about 0.001 to about 5 weight percent of the composition, preferably at about 0.005 to about 2 weight percent, with about 0.01 to about 0.1 weight percent being especially preferred.

According to preferred embodiments, the composition further includes a wetting agent. Although in some cases the high-HLB PEO-containing component may contribute to the wetting ability of the composition, the inclusion of a supplemental wetting agent ensures that the composition effectively wets contact lenses treated therewith.

Representative wetting agents include: cellulosic materials such as cationic cellulosic polymers, hydroxypropyl methycellulose, hydroxyethyl cellulose and methycellulose; polyvinyl alcohol; and polyvinyl pyrrolidone. A preferred class of wetting agents is the cationic cellulosic materials that have the ability to associate with anionic areas on a lens surface, such as rigid gas permeable (RGP) lenses, which facilitates the material wetting and cushioning the lens surface. Such materials include polyquaternium-10 available under the trade name Polymer JR-30 from Union Carbide. Other wetting agents include silicone polymers having a pendant alkyleneoxide side chain, particularly products available under the trade name Dow Corning®193 (Dow Corning, Midland, Mich., USA), and quaternized guar gums such as guar hydroxypropyltrmonium chloride and hydroxypropyl guar hydroxypropyltrmonium chloride, particularly products available under the trade name Jaguar (Rhone Polenc).

These wetting agents may be used in a wide range of concentrations, generally about 0. 1 to about 10 weight percent.

The cleaning compositions include as necessary buffering agents for buffering or adjusting pH of the composition, and/or tonicity-adjusting agents for adjusting the tonicity of the composition. Representation buffering agents include: alkali metal salts such as potassium or sodium carbonates, acetates, borates, phosphates, citrates and hydroxides; and weak acids such as acetic, boric and phosphoric acids. Representative tonicity adjusting agents include: sodium and potassium chloride, and those materials listed as buffering agents. The tonicity agents may be employed in an amount effective to adjust the osmotic value of the final composition to a desired value. Generally, the buffering agents and/or tonicity-adjusting agents may be included up to about 10 weight percent.

According to preferred embodiments, an antimicrobial agent is included in the composition in an antimicrobially effective amount, i.e., an amount that is effective to at least inhibit growth of microorganisms in the composition. Preferably, the composition can be used to disinfect a contact lens treated therewith. Various antimicrobial agents are known in the art as useful in contact lens solutions, including: chlorhexidine (1,1′-hexamethylene-bis[5-(p-chlorophenyl) biguanide]) or water soluble salts thereof, such as chlorhexidine gluconate; polyhexamethylene biguanide (a polymer of hexamethylene biguanide, also referred to as polyaminopropyl biguanide) or water-soluble salts thereof, such as the polyhexamethylene biguanide hydrochloride available under the trade name Cosmocil CQ (ICI Americas Inc.); benzalkonium chloride; and polymeric quatenary ammonium salts. When present, the antimicrobial agent may be included at 0.00001 to about 5 weight percent, depending on the specific agent.

A preferred buffer and antimicrobial agent system is based on a borate buffer and a polyhexamethylene biguanide (PHMB). According to this preferred embodiment, PHMB may be employed as the sole antimicrobial agent in an amount not exceeding 5 ppm, and preferably not exceeding 3 ppm. PHMB has relatively low eye irritation potential, and by employing the borate buffer, the amount of PHMB can be minimized to further alleviate the potential for eye irritation while maintaining adequate antimicrobial efficacy.

The compositions may further include a sequestering agent (or chelating agent) which can be present up to about 2.0 weight percent. Examples of preferred sequestering agents include ethylenediaminetetraaccetic acid (EDTA) and its salts, with the disodium salt (disodium edetate) being especially preferred.

The compositions are useful for hard and soft contact lenses. Hard lenses include polymethylmethacrylate lenses and rigid gas permeable (RGP) lenses formed of a silicon or a fluorosilicon polymer. Soft contact lenses include hydrophilic hydrogel lenses.

A contact lens is cleaned by exposing the lens to the cleaning composition, preferably by immersing the lens in the composition, followed by agitation, such as by rubbing the composition on the lens surface. The lens is then rinsed to remove the composition along with contaminants. The same composition of this invention may be used to rinse the lenses, or alternately, a separate rinsing solution can be used.

When the composition of this invention is used to rinse the lens, the composition will usually adequately wet the lens surface. Due to the low irritation potential of the composition, the lens can then be inserted directly in the eye. Alternately, the cleaned lens can be subsequently treated with the composition, such as soaking the lens in the composition for sufficient time to ensure adequate wetting of the lens surface. When treating lenses with the composition including an antimicrobial agent, it is preferred to soak the lenses for sufficient time to disinfect the lenses, in which case the composition is used for cleaning, disinfecting and wetting the lens. The treated lens can then be inserted directly in the eye without additional rinsing of the composition from the lens.

The compositions are prepared by adding the individual components to water. A representative method follows. The salts, buffers and wetting agents are added to a first batch of premeasured, heated water with mixing, and after cooling, this mixture is filtered and sterilized. The antimicrobial agents are typically added to another batch of premeasured water. The PEO-containing material and the surface active agents are added to another batch of premeasured water with mixing, and then this mixture is filtered and sterilized. Alternately, if these latter agents are stable to thermal sterilization, then they may be added directly to the first phase. Finally, the mixtures are combined with mixing.

The following examples illustrate various preferred embodiments, the components being listed by weight percent.

Example 1

| | |
|---|---|
| 0.35% | Polyquaternium-10 (cationic cellulosic polymer, Polymer |
| | JR30) |
| 0.85% | Boric acid |
| 0.10% | Sodium borate |
| 0.05% | Disodium edetate |
| 0.22% | Potassium chloride |
| 0.22% | Sodium chloride |
| 0.20% | Polysorbate 20 (Tween 20) |
| 0.10% | Methyl gluceth-20 (Glucam E-20) |
| 0.10% | Poloxamine 1107 (Tetronic 1107) |
| 0.0003% | PHMB (Cosmocil CQ) |
| Balance | Water |

Example 2

| | |
|---|---|
| 0.375% | Polyquaternium-10 (Polymer JR30) |
| 0.85% | Boric acid |
| 0.10% | Sodium borate |
| 0.05% | Disodium edetate |
| 0.22% | Potassium chloride |
| 0.22% | Sodium chloride |
| 0.50% | Polysorbate 20 (Tween 20) |
| 0.10% | Methyl gluceth-20 (Glucam E-20) |
| 0.50% | Poloxamine 1107 (Tetronic 1107) |
| 0.0003% | PHMB (Cosmocil CQ) |
| Balance | Water |

### Cleaning Efficacy Evaluation

Studies were performed to evaluate the cleaning effectiveness of formulations containing the compositions listed in Examples 1 and 2 in comparison with commercially available multi-purpose solution (BOSTON SIMPLICITY solution). Fluorosilicone acrylate rigid gas permeable lenses (RGP) contact lenses (QUANTUM I material, Polymer Technology) were artificially deposited with a mixture of proteins and lipids. After deposition, the lenses were analyzed by enhanced computer image analysis to determine deposit coverage on the surface of each lens. The lenses were then cleaned by rubbing and rinsing with the test solutions, followed by soaking for four hours in the test solutions, according to the patient instructions included with BOSTON SIMPLICITY solution. After cleaning, these lenses were re-imaged, and the percentage of removed deposits was calculated. The results are listed in the table below:

| Formulation | % Deposit Removal |
|---|---|
| BOSTON SIMPLICITY | 61.1 |
| Example 1 | 69.8 |
| Example 2 | 95.2 |

In addition to cleaning contact lenses, the compositions of Examples 1 and 2 are effective at wetting, conditioning and disinfecting contact lenses treated therewith.

The following examples illustrate additional embodiments of compositions according to this invention.

Example 3

| | |
|---|---|
| 0.85% | Boric acid |
| 0.10% | Sodium borate |
| 0.05% | Disodium edetate |
| 0.22% | Sodium chloride |
| 0.22% | Potassium chloride |
| 0.50% | Poloxamine 1308 (Tetronic 1308) |
| 0.10% | PEG-6 Lauramide (Amidox L-5) |
| 0.10% | Methyl gluceth-20 (Glucam E-20) |
| 0.35% | Polyquaternium-10 (Polymer JR 30) |
| 0.0003% | PHMB (Cosmocil CQ) |
| Balance | Water |

Example 4

| | |
|---|---|
| 0.85% | Boric acid |
| 0.10% | Sodium borate |
| 0.05% | Disodium edetate |
| 0.22% | Sodium chloride |
| 0.22% | Potassium chloride |
| 0.50% | Poloxamine 1308 (Tetronic 1308) |
| 0.10% | PEG-6 Lauramide (Amidox L-5) |
| 0.10% | Methyl gluceth-20 (Glucam E-20) |
| 0.35% | Guar hydroxypropyltrimonium chloride (Jaguar C-13S) |
| 0.0003% | PHMB (Cosmocil CQ) |
| Balance | Water |

Although various preferred embodiments have been illustrated, many other modifications and variations of the present invention are possible to the skilled practitioner. It is therefore understood that, within the scope of the claims, the present invention can be practiced other than as herein specifically described.

What is claimed:

1. An aqueous composition for cleaning and wetting a contact lens comprising:
(a) a non-amine polyethyleneoxy-containing material having an HLB value of at least about 18;
(b) a first non-ionic surface active agent having cleaning activity for contact lens deposits that comprises a poloxamine;
(c) a second non-ionic surface active agent having cleaning activity for contact lens deposits and that comprises a non- poloxamine surface active agent; and
(d) a wetting agent.

2. The composition of claim 1, comprising:
(a) about 0.001 to about 10 weight percent of the non-amine polyethyleneoxy-containing material having an HLB value of at least about 18;
(b) about 0.001 to about 5 weight percent of the first non-ionic surface-active agent having cleaning activity for contact lens deposits;
(c) about 0.001 to about 5 weight percent of the second non-ionic surface active agent having cleaning activity for contact lens deposits; and
(d) about 0.1 to about 10 weight percent of the wetting agent.

3. The composition of claim 2, comprising:
(a) about 0.001 to about 5 weight percent of the non-amine polyethyleneoxy-containing material having an HLB value of at least about 18;
(b) about 0.005 to about 2 weight percent of the first non-ionic surface-active agent having cleaning activity for contact lens deposits;
(c) about 0.001 to about 5 weight percent of the second non-ionic surface active agent having cleaning activity for contact lens deposits; and
(d) about 0.1 to about 10 weight percent of the wetting agent.

4. The composition of claim 1, wherein the non-amine polyethyleneoxy-containing material comprises at least one member selected from the group consisting of poloxamers, ethoxylated glucose derivatives, ethoxylated nonionic ethers of sorbitol, and ethoxylated nonionic ethers of glycerol having an HLB value of at least about 18.

5. The composition of claim 4, wherein the non-amine polyethyleneoxy-containing material having an HLB value of at least about 18 comprises an ethoxylated glucose derivative.

6. The composition of claim 1, wherein the second non-ionic surface active agent having cleaning activity for contact lens deposits comprises at least one member selected from the group consisting of poloxamers having an HLB value less than 18, ethoxylated alkyl phenols, polysorbates alkyl glucosides and polyglucosides.

7. The composition of claim 6, wherein the second non-ionic surface active agent comprises polysorbate 20.

8. The composition of claim 1, wherein the wetting agent comprises at least one member selected from the group consisting of cellulosic materials, polyvinyl alcohols, polyvinyl pyrrolidones and silicone polymers having a pendant alkyleneoxide side chain.

9. The composition of claim 8, wherein the wetting agent comprises a cationic cellulosic polymer.

10. The composition of claim 1, further comprising a buffering agent or tonicity adjusting agent.

11. The composition of claim 1, wherein eye irritation potential of the composition is sufficiently low such that a contact lens that has been wetted with the composition can be inserted directly in the eye.

12. The composition of claim 1, comprising:
(a) an ethoxylated glucose derivative;
(b) a poloxamine;
(c) a polysorbate;
(d) a cellulosic derivative;
(e) a borate buffer;
(f) a polyhexamethylene biguanide or salt thereof; and
(g) water.

13. A method of cleaning and wetting a contact lens comprising exposing said contact lens to an aqueous composition comprising
(a) a non-amine polyethyleneoxy-containing material having an HLB value of at least about 18;
(b) a first non-ionic surface active agent having cleaning activity for contact lens deposits that comprises a poloxamine;
(c) a second non-ionic surface active agent having cleaning activity for contact lens deposits and that comprises a non- poloxamine surface active agent; and
(d) a wetting agent.

14. The method of claim 13, wherein the non-amine polyethyleneoxy-containing material comprises at least one member selected from the group consisting of poloxamers, ethoxylated glucose derivatives, ethoxylated nonionic ethers of sorbitol, and ethoxylated nonionic ethers of glycerol having an HLB value of at least about 18.

15. The method of claim 13, wherein the second non-ionic surface active agent having cleaning activity for contact lens deposits comprises at least one member selected from the group consisting of poloxamers having an HLB value less than 18, ethoxylated alkyl phenols, polysorbates alkyl glucosides and polyglucosides.

16. The method of claim 13, wherein the wetting agent comprises at least one member selected from the group consisting of cellulosic materials, polyvinyl alcohols, polyvinyl pyrrolidones and silicone polymers having a pendant alkyleneoxide side chain.

17. The method of claim 13, wherein the composition comprises:
(a) an ethoxylated glucose derivative;
(b) a poloxamine;
(c) a polysorbate;
(d) a cellulosic derivative;
(e) a borate buffer;
(f) a polyhexamethylene biguanide or salt thereof; and
(g) water.

18. A method of cleaning and wetting a contact lens comprising:
(a) exposing said contact lens to a first dose of said aqueous composition to remove contaminants thereof; and subsequently,
(b) treating the contact lens with a second does of said composition to wet the surface of the contact lens for insertion in the eye.

19. The method of claim 18, further comprising inserting the treated contact lens directly in the eye.

20. A method of cleaning, wetting and disinfecting a contact lens comprising:
(A) cleaning said contact lens by exposing said lens to a treatment solution to remove deposits therefrom, said solution comprising (i) a non-amine polyethyleneoxy-containing material having an HLB value of at least about 18; (ii) a first non-ionic surface active agent having cleaning activity for contact lens deposits that comprises a poloxamine; (iii) a second non-ionic surface active agent having cleaning activity for contact lens deposits and that comprises a non-poloxamine surface active agent; (iv) a wetting agent; and (v) an antimicrobial agent;
(B) disinfecting and wetting said lens by soaking said lens in said solution; and
(C) inserting the disinfected lens directly in the eye.
